(19) United States
(12) Patent Application Publication
(10) Pub. No.: US 2007/0128454 A1
(43) Pub. Date: Jun. 7, 2007

(54) Silicone-based coating composition with middle and high refractive index, method of preparing the same, and optical lens prepared therefrom

(76) Inventors: Sang-Hyuk Im, Yuseong-gu (KR); Do-Hyun Jin, Cheongju-shi (KR); Jong-Pyo Kim, Nam-gu (KR); Seung-Heon Lee, Seo-gu (KR); Young-Jun Hong, Yuseong-gu (KR)

Correspondence Address: MCKENNA LONG & ALDRIDGE LLP, 1900 K STREET, NW, WASHINGTON, DC, 20006, US

(21) Appl. No.: 11/606,965

(22) Filed: Dec. 1, 2006

(30) Foreign Application Priority Data
Dec. 1, 2005 (KR) 10-2005-0116346
Oct. 19, 2006 (KR) 10-2006-0101914

(51) Int. Cl. B32B 27/00; C08L 83/04; C08G 77/00

(52) U.S. Cl. 428/447; 524/588; 525/477

(57) ABSTRACT

The present invention relates to a silicone-based coating composition with middle and high refractive index, a method of preparing the same, and an optical lens prepared therefrom, and more specifically to a silicone-based coating composition including organosilanes, inorganic oxides having a refractive index of from 1.7 to 3.0, an aluminum acetyl acetone, a C₁-C₅ alkyl cellosolve, and a solvent, a method of preparing the same, and an optical lens prepared therefrom. The siloxane-based coating composition is transparent, not sticky, and stable for long time storage. Therefore, the coating composition can be applied to a coating layer on a surface of a plastic lens such as an optical lens, an industrial safety lens, or goggles for leisure.

### CROSS REFERENCES TO RELATED APPLICATION

This application claims priority to and the benefit of Korean Patent Application Nos. 10-2005-0116346 filed on Dec. 1, 2005, and 10-2006-0101914 filed on Oct. 19, 2006 in the Korean Industrial Property Office, and both of which are hereby incorporated by reference for all purpose as if fully set forth herein.

### BACKGROUND OF THE INVENTION

(a) Field of the Invention

The present invention relates to a silicone-based coating composition with middle and high refractive index, a method of preparing the same, and an optical lens prepared therefrom, and more specifically, to a silicone-based coating composition with middle and high refractive index, which is transparent, not sticky, stable for long time storage, and applicable to a coating layer for a plastic lens such as an optical lens, an industrial glass, or goggles for leisure, a method of preparing the same, and an optical lens prepared therefrom.

(b) Description of the Related Art

Usually, a glass has been used for a lens having high degree because it has high compression efficiency and good abrasion resistance. However, because the glass breaks easily by impact and it is difficult to dye and give a functionality, such as UV-protection, to it, glass lenses are being replaced by transparent plastic lenses.

Plastic materials have merits of transparency, light weight, burst resistance, and good dyeability, and also it is easy to give various functions thereto. Therefore, the plastic lenses are being applied to optical lenses, especially, industrial glasses, and goggles for leisure.

However, the use of plastic materials for lenses is limited because the soft surface of the plastics can be easily scratched and cracked by impact.

In order to make up for the problem, coating compositions such as organic materials or silicon materials having good abrasion resistance are used for forming coating layers on the surface of the plastic lenses.

It is preferable that said coating compositions for plastic lenses have good abrasion resistance, dyeability, solvent resistance, hot water resistance, adhesion property, gloss, transparency, and stability for work and storage. However, known coating compositions lack at least one of said properties, and thus the use of said coating compositions for plastic lenses is limited.

Korean Patent Publication No. 1998-0002185 discloses a siloxane-based coating composition having good storage stability, abrasion resistance, and dyeability. However the siloxane-based coating composition is not suitable for fine components such as optical lenses by reason of poor transparency.

Korean Patent Publication No. 2000-0020026 discloses an abrasion resistant coating composition having good impact resistance. However, when the coating composition is used for goggles for leisure, it is difficult to obtain high quality goggles by reason of its low dyeability and low gloss.

Korean Patent Publication No. 2002-0009786 discloses a siloxane-based coating composition having enhanced adhesion property, gloss, and stability for working and storage. Though the siloxane-based coating composition has said enhanced properties, its dyeability is poor and some cracks appear on the surface of the coating layer during the test for hot water resistance. Therefore, the coating composition is inadequate for a coating layer of a plastic lens.

### SUMMARY OF THE INVENTION

In order to overcome the problems above, it is an aspect of the present invention to provide a silicone-based coating composition with middle and high refractive index, which is transparent, not sticky, and stable for long time storage.

It is another aspect of the present invention to provide a method of preparing the silicone-based coating composition with middle and high refractive index.

Still another aspect of the present invention is to provide an optical lens including a coating layer prepared with the coating composition.

In order to attain these objects, the present invention provides a siloxane-based coating composition including:

a) 0.1 to 50 parts by weight of a compound(s) represented by the following Chemical Formula 1, a hydrolysate(s) thereof, or a partial condensate(s) thereof;

b) 10 to 60 parts by weight of a compound(s) represented by the following Chemical Formula 2, a hydrolysate(s) thereof, or a partial condensate(s) thereof;

c) 1.0 to 100 parts by weight of an inorganic oxide(s) having a refractive index of from 1.7 to 3.0;

d) 1.0 to 100 parts by weight of an aluminum acetyl acetone;

e) 1.0 to 30 parts by weight of a C₁-C₅ alkyl cellosolve; and

f) 10 to 130 parts by weight of a solvent(s).
R¹ₐ(SiOR²)₄₋ₐ Chemical Formula 1
R³_{b}Si(OR⁴)_{4-b} Chemical Formula 2

Wherein:

R¹ and R² are independently selected from the group consisting of a C₁-C₆ alkyl, a C₁-C₆ alkenyl, a C₁-C₆ halogenated alkyl, an allyl, and a C₃-C₆ aromatic group;

R³ 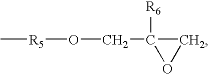
wherein R⁵ is a C₁-C₄ alkylene, and R⁶ is selected from the group consisting of hydrogen, a C₁-C₄ alkyl, and 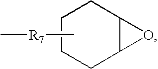
in which R⁷ is selected from the group consisting of hydrogen, a C₁-C₄ alkylene, and a C₁-C₄ alkyl;

R⁴ is a C₁-C₆ alkyl;

a is an integer from 0 to 3; and

b is an integer from 0 to 3.

Furthermore, the present invention provides a method of preparing a siloxane-based coating composition including the steps of:

a) preparing an organic-inorganic sol by mixing at least one compound represented by Chemical Formula 1, hydrolysates thereof, or partial condensates thereof, and at least one compound represented by Chemical Formula 2, hydrolysates thereof, or partial condensates thereof in the presence of a solvent and a catalyst, and then conducting a sol-gel reaction; and

b) adding an inorganic oxide(s) having a refractive index of from 1.7 to 3.0 into the organic-inorganic sol, wherein an aluminum acetyl acetone and a C₁-C₅ alkyl cellosolve are added in at least one of step a) and step b).

Furthermore, the present invention provides an optical lens including a coating layer(s) prepared from said coating composition and having a refractive index of from 1.5 to 1.65.

### DETAILED DESCRIPTION OF THE PREFERRED EMBODIMENTS

Hereinafter, the present invention is explained in more detail.

The siloxane-based coating composition includes an organosilane compound and an aluminum acetyl acetone. The coating composition is transparent and stable for long time storage because the aluminum acetyl acetone forms a chelate with the hydroxyl group of the organosilane. Furthermore, the coating composition is not sticky owing to the C₁-C₅ alkyl cellosolve included therein as a stabilizer.

Therefore, said siloxane-based coating composition is applicable to a coating layer of various optical lenses, and especially to a coating layer for an industrial safety glass or goggles for leisure.

The coating composition of the present invention includes a) an organic silane compound(s) represented by Chemical Formula 1, a hydrolysate(s) thereof, or a partial condensate(s) thereof, and b) an organic silane compound(s) represented by Chemical Formula 2, a hydrolysate(s) thereof, or a partial condensate(s) thereof,
R¹ₐ(SiOR²)₄₋ₐ Chemical Formula 1
R³_{b}Si(OR⁴)_{4-b} Chemical Formula 2

wherein:

R¹ and R² are independently selected from the group consisting of a C₁-C₆ alkyl, a C₁-C₆ alkenyl, a C₁-C₆ halogenated alkyl, an allyl, and a C₃-C₆ aromatic group;

R³ is 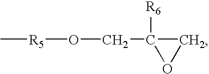
wherein R⁵ is a C₁-C₄ alkylene, and R⁶ is selected from the group consisting of hydrogen, a C₁-C₄ alkyl, and 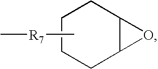
in which R⁷ is selected from the group consisting of hydrogen, a C₁-C₄ alkylene, and a C₁-C₄ alkyl;

R⁴ is a C₁-C₆ alkyl;

a is an integer from 0 to 3; and

b is an integer from 0 to 3.

In said compound(s) represented by Chemical Formula 1, when the subscript ‘a’ is 1 or more, it is most proper that R¹ is methyl. As the alkyl group of R¹ becomes longer, the softness of the coating layer increases and the properties of the prepared coating layer deteriorate.

The organosilane compound having the methyl group and the other organosilane compound having the other substituting group(s) can be used together as necessary. However, the moles of the organosilane having the methyl group(s) must be larger than the moles of the other organosilane compounds. Furthermore, when the subscript ‘a’ of the Chemical Formula 1 is 0, it is proper that R² is a C₁-C₆ alkyl.

More specifically, said compound represented by Chemical Formula 1 can be at least one compound selected from the group consisting of methyl trimethoxy silane, methyl triethoxy silane, vinyl trimethoxy silane, vinyl triethoxy silane, dimethyl dimethoxy silane, dimethyl diethoxy silane, vinyl methyl dimethoxy silane, butyl trimethoxy silane, diphenyl ethoxy vinyl silane, methyl triisopropoxy silane, methyl triacethoxy silane, tetraphenoxy silane, tetrapropoxy silane, and vinyl triisopropoxy silane.

The organosilane compound represented by Chemical Formula 1 may be included in the coating composition in an amount of from 0.1 to 50 parts by weight of the total composition, and more preferably from 1.0 to 30 parts by weight of the total composition. When the content of the organosilane compound is below this range, the abrasion resistance of the coating layer may be decreased, and, on the contrary, when the content of the organosilane compound is above this range, some cracks may appear on the surface of the coating layer during the hot water resistance test.

Furthermore, the organosilane compound represented by Chemical Formula 2 has an epoxy group(s) as a functional group, and thus the organosilane compound enables coloring or dyeing of the coating layer with an organic dye during hardening the coating composition of the present invention.

More specifically, said compound(s) represented by Chemical Formula 2 can be at least one compound selected from the group consisting of 3-glycydoxy propyl trimethoxy silane, 3-glycydoxy propyl triethoxy silane, 3-glycydoxy propyl methylmethoxy silane, 3-glycydoxy propyl methylethoxy silane, and β-(3,4-epoxy cyclohexyl) ethyl trimethoxy silane.

The organosilane compound represented by Chemical Formula 2 may be included in the coating composition in an amount of from 10 to 60 parts by weight of the total composition, and more preferably from 20 to 40 parts by weight of the total composition. When the content of the organosilane compound is below this range, some cracks may appear on the surface of the coating layer during the hot water resistance test, and, on the contrary, when the content of the organosilane compound is above this range, the abrasion resistance of the coating layer may be decreased. Therefore it is preferable that the content of said organosilane compound represented by Chemical Formula 2 is controlled within the above range.

However, when the coating composition including the organo silanes is preserved for a long time, the coating composition may be aggregated and sticky, because of the condensation reaction of hydroxyl groups existing on the surface of the organic-inorganic sol. Therefore, the siloxane-based coating composition includes an aluminum acetyl acetone being capable of forming a chelate with a hydroxyl group (OH) of the organosilane to enhance the storage stability and coating workability of the coating composition.

Said aluminum acetyl acetone may be included in the coating composition in an amount of from 0.01 to 10 parts by weight of the total composition, and more preferably from 0.1 to 5 parts by weight of the total composition.

When the content of the aluminum acetyl acetone is below this range, the effect of adding the aluminum acetyl acetone is insignificant and the workability may be decreased, because the coating layer becomes sticky during drying, and, on the contrary, when the content of the aluminum acetyl acetone is above this range, the abrasion resistance of the coating layer may be decreased. Therefore it is preferable that the content of said aluminum acetyl acetone is controlled within the above range.

Furthermore, the coating composition includes a C₁-C₅ alkyl cellosolve as a stabilizer for improving the storage stability. Said C₁-C₅ alkyl cellosolve can be at least one compound selected from the group consisting of methyl cellosolve, ethyl cellosolve, butyl cellosolve, and isopropyl cellosolve.

Said alkyl cellosolve may be included in the coating composition in an amount of from 1.0 to 30 parts by weight of the total composition, and more preferably from 5 to 20 parts by weight of the total composition. When the content of the alkyl cellosolve is below this range, the storage stability of the coating composition is decreased and aggregation of the organic-inorganic sol may occur, and, on the contrary, when the content of the alkyl cellosolve is above this range, the coating layer becomes sticky during drying, and the coatability becomes worse. Therefore it is preferable that the content of said alkyl cellosolve is controlled within the above range.

Furthermore, the present invention includes an inorganic oxide with a predetermined content in order to exhibit middle and high refractive properties and to improve an abrasion property.

Said inorganic oxide has a refractive index of from 1.7 to 3.0, and more preferably may be a multi-component oxide(s) including two or more compounds selected from the group consisting of TiO₂ (refractive index: 2.5-2.7), SiO₂ (refractive index: 1.5), ZrO₂ (refractive index: 2.2), SnO₂ (refractive index: 2.0), Ce₂O₃ (refractive index: 2.2), BaTiO₃ (refractive index: 2.4), Al₂O₃ (refractive index: 1.73), and Y₂O₃ (refractive index: 1.92).

Said multi-component oxide(s) may be composed at adequate contents by their refractive index, and more preferably, at least one of TiO₂—ZrO₂—SnO₂, TiO₂—ZrO₂—SiO₂ and TiO₂—SnO₂—SiO₂ may be used.

Said inorganic oxide enables the refractive index of the coating layer prepared from the coating composition to be within the range of from 1.5 to 1.65, so as to show middle and high refractive properties.

It is preferable that the inorganic oxide maintains a stable dispersion state in the coating composition, and thus the particle size of the inorganic oxide is preferably from 5 nm to 30 nm, considering the transparency of the coating layer.

Said inorganic oxide may be included in the coating composition in an amount of from 1.0 to 100 parts by weight of the total composition, and more preferably from 5 to 80 parts by weight of the total composition. When the content of the inorganic oxide is below this range, it is difficult to prepare the coating layer having an adequate refractive index, and, on the contrary, when the content of the inorganic oxide is above this range, the hardness of the coating layer is seriously deteriorated because the inorganic oxide may be a cracking spot and so the coating layer becomes cleaved or cracked. Therefore the content of said inorganic oxide may be controlled within the above range.

Furthermore, the pH and the reaction speed must be controlled during preparing the coating composition with considering various properties of the coating layer, such as storage stability, and abrasion resistance. For this object, a catalyst may be used in the process for preparing the coating composition. Preferable examples of the catalyst may be an acidic catalyst or a basic catalyst, wherein the acidic catalyst may be at least one acid compound selected from the group consisting of acetic acid, phosphoric acid, sulfuric acid, chloric acid, nitric acid, chlorosulfonic acid, p-toluene sulfonic acid, trichloroacetic acid, polyphosphoric acid, iodic acid, iodic anhydride, and perchloric acid, and the basic catalyst may be at least one base selected from the group consisting of sodium hydroxide, potassium hydroxide, n-butyl amine, di-n-butyl amine, imidazole, and ammonium perchlorate.

Said catalysts may be used alone or in combination with two or more of said compounds, considering the final pH of the coating composition, reaction speed classified by the ingredients of the coating composition, and adhesion property for applying to a substrate.

The solvent used in the process of the present invention may be at least one solvent selected from the group consisting of methanol, ethanol, isopropanol, n-propanol, n-butanol, sec-butanol, t-butanol, ethyl acetate, methyl acetate, xylene, and toluene. Said solvent may be used in an amount of from 10 to 130 parts by weight of the total composition, and more preferably 30 to 100 parts by weight of the total composition.

The abrasion resistant siloxane-based coating composition of the present invention may further include various additives within a range not debasing the properties of the coating composition for the purpose of enhancing adhesion to a substrate, workability, anti reflection property, etc.

Preferable examples of the additives are polyolefin-based epoxy resin, cyclohexane oxide, polyglycidyl esters, bisphenol A type epoxy resin, epoxy acrylate resin, or a UV absorber such as a benzophenone-based compound, a benzotriazole-based compound, and a phenol-based compound.

Furthermore, various surfactants can be included in the coating composition for improving coatability, and the surfactant may be a block copolymer or a graft copolymer of dimethyl siloxane and polyether, or a fluorinated surfactant.

The coating composition can be prepared by the method including the steps of: a) preparing an organic-inorganic sol by mixing at least one compound represented by Chemical Formula 1, hydrolysates thereof, or partial condensates thereof, and at least one compound represented by Chemical Formula 2, hydrolysates thereof, or partial condensates thereof in the presence of a solvent and a catalyst, and then conducting a sol-gel reaction; and b) adding an inorganic oxide(s) having a refractive index of from 1.7 to 3.0 into the organic-inorganic sol, wherein an aluminum acetyl acetone and a C₁-C₅ alkyl cellosolve are added in at least one of step a) and step b).

More preferably, the sol-gel reaction of step a) may be conducted at a temperature of from 20 to 40° C.

The organic-inorganic sols have a stable molecular state because the compounds represented by Chemical Formulae 1 and 2 form a 3-dimensional network structure by the sol-gel reaction, and thus the coating layer having good adhesion property can be obtained quickly from the coating composition at low temperature.

In step b), an inorganic oxide(s) having a refractive index of from 1.7 to 3.0 is added into the organic-inorganic sol prepared by step a).

The aluminum acetyl acetone and the alkyl cellosolve may be added in step a), step b), or both step a) and b), and more preferably may be added before or after the sol-gel reaction of step a). However, it is more preferable to add the alkyl cellosolve after adding the aluminum acetyl acetone.

Said aluminum acetyl acetone may form a chelate with a hydroxyl group (OH) of the organosilane, and prevent aggregation of the organic-inorganic sol of the coating composition by inhibiting the condensation reaction of hydroxyl groups existing on the surface of the organic-inorganic sol.

The coating layer prepared from the coating composition of the present invention has a refractive index of from 1.5 to 1.65, and thus the coating layer can be used as a middle and high refractive coating layer for various optical lenses, especially for plastic lenses such as industrial safety glasses or goggles for leisure, to enhance qualities of the plastic lens.

The silicone-based coating composition of the present invention is stable for long time storage, and it has excellent workability because the coating composition is easy to dry, and thus pollution by dust decreases during the coating process.

The coating layer prepared from the coating composition has a hardness of from 4H to 8H, and shows good transparency of from 30 to 70% after dyeing as well as a good adhesion property measured by a hot water resistance test.

Furthermore, the coating layer has high abrasion resistance, solvent resistance, and optical transparency, and discoloring after hardening does not occur.

Said coating layer can be prepared by coating the coating composition on a surface of an optical lens, specifically, a plastic lens such as an industrial safety glass or goggles for leisure, and by drying and hardening the coated composition, according to a common coating method.

The hardening condition after coating may be different in accordance with the mixing ratio or components of the coating composition. However, it is preferable to harden the coating layer at a temperature from 60 to 150° C., which is below the softening point of the substrate, for 20 minutes to 10 hours.

The coating method of the present invention is not particularly limited and a general wet coating process can be applied to the present invention, but it is preferable that any one process selected from roll coating, spray coating, dip coating, or spin coating is applied to the present invention.

The coating layer prepared from the coating composition may be dyed by dispersion dyes. In the dyeing process, the conditions such as concentration of the dye, temperature, and time may be freely determined, however it is preferable that the dyeing process is proceeded by dipping the coating layer into 0.1 to 1 weight % of aqueous dye solution at a temperature of from 80 to 100° C. for 5 to 10 minutes

Hereinafter, the present invention is described in further detail through examples. However, the following examples are only for the understanding of the present invention and the present invention is not limited to or by them.

### EXAMPLE 1

(Preparation of a Coating Composition)

100 g of tetraethoxy silane, 250 g of glycidoxypropyl trimethoxy silane, and 100 g of methanol were introduced in a jacket reactor maintaining room temperature and agitated for 5 minutes.

10 g of an aluminum acetyl acetone was added in the jacket reactor and agitated for 5 minutes, and then 80 g of aqueous acetic acid solution having pH 2.5 was added in the jacket reactor, and subjected to sol-gel reaction for 3 hours with agitating.

After the sol-gel reaction, the temperature of the reactor was adjusted to 25° C., and 350 g of TiO₂—SiO₂—ZrO₂ dispersion solution (made by Nissan Chemical Co., DH-40, diameter 7-9 nm, spherical, crystal phase, refractive index 2.0, solid content 30 wt %, dispersed in methanol) was added to the sol solution prepared by said sol-gel reaction.

After agitating the mixture for 1 hour, 100 g of butyl cellosolve was added thereto to produce a siloxane-based coating composition.

(Preparation of a Coating Layer)

After etching a high refractive lens for glasses (made by Chemiglass Co., MR-8, refractive index 1.59), said coating composition was coated on the lens by a dipping method, and hardened for 2 hours at 110° C. to produce a coating layer.

### EXAMPLE 2

The siloxane-based coating composition and the coating layer were prepared substantially according to the same method as Example 1, except that butyl cellosolve was substituted with methyl cellosolve.

### EXAMPLE 3

The siloxane-based coating composition and the coating layer were prepared substantially according to the same method as Example 1, except that butyl cellosolve was substituted with ethyl cellosolve.

### EXAMPLE 4

The siloxane-based coating composition and the coating layer were prepared substantially according to the same method as Example 1, except that butyl cellosolve was substituted with isopropyl cellosolve.

### EXAMPLE 5

The siloxane-based coating composition and the coating layer were prepared substantially according to the same method as Example 1, except that 5 g of an aluminum acetyl acetone was added in the coating composition.

### EXAMPLE 6

The siloxane-based coating composition and the coating layer were prepared substantially according to the same method as Example 1, except that 20 g of an aluminum acetyl acetone was added in the coating composition.

### EXAMPLE 7

The siloxane-based coating composition and the coating layer were prepared substantially according to the same method as Example 1, except that the aluminum acetyl acetone was added after the sol-gel reaction.

### EXAMPLE 8

The siloxane-based coating composition and the coating layer were prepared substantially according to the same method as Example 1, except that 50 g of butyl cellosolve was added before the sol-gel reaction and 300 g of butyl cellosolve was added after the sol-gel reaction.

### EXAMPLE 9

The siloxane-based coating composition and the coating layer were prepared substantially according to the same method as Example 1, except that 170 g of TiO₂—SiO₂—ZrO₂ dispersion solution (made by Nissan Chemical, DH-40, diameter 7-9 nm, spherical, crystal phase, refractive index 2.0, solid content 30 wt %, dispersed in methanol) was added in the coating composition

### COMPARATIVE EXAMPLE 1

The siloxane-based coating composition and the coating layer were prepared substantially according to the same method as Example 1, except that the aluminum acetyl acetone was not added in the coating composition.

### COMPARATIVE EXAMPLE 2

The siloxane-based coating composition and the coating layer were prepared substantially according to the same method as Example 1, except that 100 g of an acetyl acetone was added in the coating composition without adding butyl cellosolve.

### COMPARATIVE EXAMPLE 3

The siloxane-based coating composition and the coating layer were prepared substantially according to the same method as Example 1, except that 100 g of an acetyl acetone was added in place of adding an aluminum acetyl acetone and butyl cellosolve.

### COMPARATIVE EXAMPLE 4

The siloxane-based coating composition and the coating layer were prepared substantially according to the same method as Example 1, except that 10 g of aluminum isopropoxide was added in place of adding an aluminum acetyl acetone.

### EXPERIMENTAL EXAMPLE 1

### Testing Properties of the Siloxane-Based Coating Composition

Storage stability and workability of the siloxane-based coating compositions prepared by the Examples and Comparative Examples were tested and the results are listed in the following Table 1.

A: Storage Stability

Viscosity and precipitation rate were evaluated after storing for 1 month at 25° C.

⊚: viscosity change of 1 cP or less, and precipitation rate of below 0.1%

∘: viscosity change of over 1 cP and 3 cP or less, and precipitation rate of 0.1% or more and below 0.5%

Δ: viscosity change of over 3 cP, and precipitation rate of 0.5% or more

B: Workability

Workability was tested after coating the coating compositions and drying for 10 minutes at 60° C.

∘: the surface of the coating layer was totally dried, and thus the surface was not sticky when it was touched by hand

Δ: the surface of the coating layer was insufficiently dried, and thus the surface was sticky when it was touched by hand

×: the surface of the coating layer was poorly dried, and thus when it was touched by hand, the surface stained the hand

TABLE 1

| | | | | | Comparative | Comparative | Comparative | Comparative |
|---|---|---|---|---|---|---|---|---|
| | Example 1 | Example 2 | Example 3 | Example 4 | Example 1 | Example 2 | Example 3 | Example 4 |
| Storage | ⊚ | ◯ | ◯ | ◯ | ◯ | ◯ | Δ | Δ |
| Stability | | | | | | | | |
| Workability | ◯ | ◯ | ◯ | ◯ | X | Δ | X | X |

Referring to the above Table 1, the coating compositions including butyl cellosolve and an aluminum acetyl acetone of the present invention had good storage stability and workability because there were no precipitations in the composition after a long time, and the coating layers were easily dried and not sticky.

On the contrary, the composition prepared by Comparative Example 1 was slightly precipitated with the passing of time, and specifically the coating layer was very sticky and the drying property of the coating layer was bad, because the coating composition did not include an aluminum acetyl acetone.

In the case of Comparative Example 2, the storage stability of the composition was not bad. However, the coating composition included an acetyl acetone in place of butyl cellosolve, and thus workability thereof was bad, because the coating layer was insufficiently dried and sticky.

In the case of Comparative Example 3, both the storage stability and workability were poor because the coating composition included an acetyl acetone in place of an aluminum acetyl acetone and butyl cellosolve.

In the case of Comparative Example 4, drying of the coating layer was good owing to using aluminum isopropoxide in place of an aluminum acetyl acetone. However severe precipitations occurred in the coating composition with the passing of time.

### EXPERIMENTAL EXAMPLE 2

### Testing Properties of the Coating Layers

The properties of the coating layer prepared by the Examples and Comparative Examples were tested according to the following Table 2, and the results as listed in the following Table 3.

TABLE 2

| | |
|---|---|
| Appearance | Appearance of the coating layer was observed with bare eyes after hardening. |
| | Interference pattern: existence and nonexistence of rainbow-colored interference. |
| | Clarity: |
| | ∘: Change of Haze after coating is 1 or less |
| | Δ: Change of Haze after coating is over 1 |
| Abrasion | Scratches of the coated lens were observed after rubbing the lens 5 times with 0000 |
| resistance | steel wool bound to a 1 kg hammer. |
| | 1. Not scratched: number of scratches is 0 |
| | 2. Slightly scratched: number of fine scratches of 1 cm or less is 3 or less, or |
| | number of long scratches of over 1 cm is 1 or less |
| | 3. Severely scratched: number of fine scratches of 1 cm or less is over 3, or number |
| | of long scratches of over 1 cm is over 1 |
| Adhesion | According to ASTM D3359, the coating layer was divided into 100 sections of 1 mm × 1 mm, |
| property | and an exfoliation test was conducted by using a cellophane tape of |
| | width 24 mm (Japan, Nichban Co.), 10 times. |
| | Adhesion property was determined by counting the number of sections that were |
| | not exfoliated. |
| Solvent | The appearance of the coating layer was observed after rubbing the coating layer |
| resistance | with a ball of cotton wetted with isopropyl alcohol and acetone 100 times. |
| Hot water | The coated high refractive lens (MR8: Chemiglass Co.) was dipped in boiling |
| resistance | water of 100° C. for 10 minutes, and appearance and adhesion tests were |
| | conducted. |
| Discoloration | The color of the lens was observed with bare eyes after hardening. |
| after hardening | |
| Dyeability | Transmittance of the coated lens was measured after dipping the lens into 0.2 wt % |
| | of aqueous BPI Sunbrown Dye solution (Brain Power Inc. co.) for 5 minutes at |
| | 90° C. |
| Refractive | The coating composition was coated on a silicone wafer and then hardened. |
| index | Refractive index was measured by using a prism coupler at five different points |
| | and the average thereof was calculated. |

TABLE 3

| | | | | | | Comparative | Comparative | Comparative | Comparative |
|---|---|---|---|---|---|---|---|---|---|
| | | Example 1 | Example 2 | Example 3 | Example 4 | Example 1 | Example 2 | Example 3 | Example 4 |
| Appearance | Interferance | No | No | No | No | No | No | No | No |
| | Clarity | ◯ | ◯ | ◯ | ◯ | ◯ | ◯ | ◯ | Δ |
| Abrasion | | 1 | 1 | 1 | 1 | 2 | 2 | 3 | 2 |
| resistance | | | | | | | | | |
| Adhesion | | 100/ | 100/ | 100/ | 100/ | 100/ | 100/ | 100/ | 100/ |
| property | | 100 | 100 | 100 | 100 | 100 | 100 | 100 | 100 |
| Solvent | | OK | OK | OK | OK | OK | OK | OK | OK |
| resistance | | | | | | | | | |
| Hot | Appearance | OK | OK | OK | OK | OK | OK | OK | OK |
| water | Adhesion | 100/ | 90/ | 100/ | 100/ | 60/ | 100/ | 70/ | 100/ |
| resistance | | 100 | 100 | 100 | 100 | 100 | 100 | 100 | 100 |

| | | | | | | | | |
|---|---|---|---|---|---|---|---|---|
| Discoloration | No | No | No | No | No | No | No | No |
| after hardening | | | | | | | | |
| Dyeability (%) | 70% | 68% | 70% | 67% | 75% | 70% | 73% | 78% |
| Refractive index | 1.59 | 1.59 | 1.59 | 1.59 | 1.58 | 1.59 | 1.58 | 1.60 |

Referring to the above Table 3, the coating layers prepared by using an aluminum acetyl acetone and alkyl cellosolve according to Examples 1 to 4 had a high refractive index of from 1.58 to 1.59, and also were good in the tests of appearance, abrasion resistance, adhesion property, solvent resistance, hot water resistance, and discoloration after hardening. Furthermore, the dyeing properties thereof were good, showing a transmittance of 70% or less.

The coating layer prepared by Comparative Example 1 had a good adhesion property at room temperature, however the abrasion resistance thereof was not good, and the coating layer was severely separated from the substrate after subjecting it to the hot water resistance test. Furthermore, the coating layer showed a relatively high transmittance of 75% in the dyeability test, and thus it can be understood that the dye could not be fixed in the coating layer.

In the case of Comparative Example 2, the adhesion property of the coating layer was good after subjecting it to the hot water resistance test. However the coating layer had poor abrasion resistance and many scratches occurred on the surface thereof by the abrasion test, because the coatability of the coating composition was poor. Therefore the coating layer prepared by Comparative Example 2 was not applicable to a coating layer of a lens.

In the case of Comparative Example 3, the appearance and adhesion properties were good and discoloring after hardening did not occur. However, abrasion resistance and hot water resistance were very low. Especially, the coating layer after hardening had poor abrasion resistance due to poor coatability of the coating composition, which is sticky in the drying process thereof, and the coating layer was easily separated from the substrate after the hot water resistance test. Furthermore, the coating layer showed a relatively high transmittance of 73% in the dyeability test, and thus it can be understood that the dye could not be uniformly dispersed and fixed in the coating layer.

In the case of Comparative Example 4, adhesion properties at room temperature and after hot water resistance testing were good and discoloring after hardening did not occur. However, the clarity of the coating layer was bad, because the precipitation owing to low storage stability of the coating composition diminished the clarity of the coating layer after hardening. Furthermore, the coating layer showed grade ‘2’ in the abrasion resistance test and a high transmittance of 78% in the dyeability test,

As mentioned above, the siloxane-based coating composition of the present invention is great in storage stability and workability because the coating composition can be easily dried and thus it is hardly polluted by dusts in the coating process. Furthermore, the prepared coating layer has good abrasion resistance, solvent resistance, and hot water resistance while maintaining good clarity, and discoloring after hardening does not occur. Therefore, the coating layer of the present invention can be applied to a coating layer for a plastic lens, such as an optical lens, an industrial glass, or goggles for leisure.

Although the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A siloxane-based coating composition comprising:
a) 0.1 to 50 parts by weight of a compound(s) represented by the following Chemical Formula 1, a hydrolysate(s) thereof, or a partial condensate(s) thereof;
b) 10 to 60 parts by weight of a compound(s) represented by the following Chemical Formula 2, a hydrolysate(s) thereof, or a partial condensate(s) thereof;
c) 1.0 to 100 parts by weight of an inorganic oxide(s) having a refractive index of from 1.7 to 3.0;
d) 0.01 to 10 parts by weight of an aluminum acetyl acetone;
e) 1.0 to 30 parts by weight of a C₁-C₅ alkyl cellosolve; and
f) 10 to 130 parts by weight of a solvent(s),
R¹ₐ(SiOR²)_{4-a,} Chemical Formula 1
R³_{b}Si(OR⁴)_{4-b,} Chemical Formula 2
wherein,
R¹ and R² are independently selected from the group consisting of a C₁-C₆ alkyl, a C₁-C₆ alkenyl, a C₁-C₆ halogenated alkyl, an allyl, and a C₃-C₆ aromatic group,
R³ is 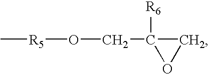
wherein R⁵ is a C₁-C₄ alkylene, and R⁶ is selected from the group consisting of hydrogen, a C₁-C₄ alkyl, and 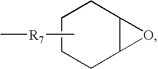
in which R⁷ is selected from the group consisting of hydrogen, a C₁-C₄ alkylene, and a C₁-C₄ alkyl,
R⁴ is a C₁-C₆ alkyl,
a is an integer from 0 to 3, and
b is an integer from 0 to 3.

2. The siloxane-based coating composition according to claim 1, wherein said compound represented by Chemical Formula 1 is at least one compound selected from the group consisting of methyl trimethoxy silane, methyl triethoxy silane, vinyl trimethoxy silane, vinyl triethoxy silane, dimethyl dimethoxy silane, dimethyl diethoxy silane, vinyl methyl dimethoxy silane, butyl trimethoxy silane, diphenyl ethoxy vinyl silane, methyl triisopropoxy silane, methyl triacethoxy silane, tetraphenoxy silane, tetrapropoxy silane, and vinyl triisopropoxy silane.

3. The siloxane-based coating composition according to claim 1, wherein said compound represented by Chemical Formula 2 is at least one compound selected from the group consisting of 3-glycydoxy propyl trimethoxy silane, 3-glycydoxy propyl triethoxy silane, 3-glycydoxy propyl methylmethoxy silane, 3-glycydoxy propyl methylethoxy silane, and β-(3,4-epoxy cyclohexyl) ethyl trimethoxy silane.

4. The siloxane-based coating composition according to claim 1, wherein said inorganic oxide is a multi-component oxide(s) comprising two or more compounds selected from the group consisting of TiO₂, SiO₂, ZrO₂, SnO₂, Ce₂O₃, BaTiO₃, Al₂O₃, and Y₂O₃.

5. The siloxane-based coating composition according to claim 4, wherein said inorganic oxide is one or more multicomponent oxide selected from the group consisting of TiO₂—ZrO₂—SnO₂, TiO₂—ZrO₂—SiO₂ and TiO₂—SnO₂—SiO₂.

6. The siloxane-based coating composition according to claim 1, wherein said inorganic oxide has a particle size of from 5 nm to 30 nm.

7. The siloxane-based coating composition according to claim 1, wherein said C₁-C₅ alkyl cellosolve is at least one compound selected from the group consisting of methyl cellosolve, ethyl cellosolve, butyl cellosolve, and isopropyl cellosolve.

8. The siloxane-based coating composition according to claim 1, wherein said solvent is at least one solvent selected from the group consisting of methanol, ethanol, isopropanol, n-propanol, n-butanol, sec-butanol, t-butanol, ethyl acetate, methyl acetate, xylene, and toluene.

9. A method of preparing a siloxane-based coating composition comprising the steps of:
a) preparing an organic-inorganic sol by mixing at least one compound represented by Chemical Formula 1, hydrolysates thereof, or partial condensates thereof. and at least one compound represented by Chemical Formula 2, hydrolysates thereof, or partial condensates thereof in the presence of a solvent and a catalyst, and then conducting a sol-gel reaction; and
b) adding an inorganic oxide(s) having a refractive index of from 1.7 to 3.0 into the organic-inorganic sol,
wherein an aluminum acetyl acetone and a C₁-C₅ alkyl cellosolve are added in at least one of step a) and step b),
R¹ₐ(SiOR²)_{4-a,} Chemical Formula 1
R³_{b}Si(OR⁴)_{4-b,} Chemical Formula 2
wherein,
R¹ and R² are independently selected from the group consisting of a C₁-C₆ alkyl, a C₁-C₆ alkenyl, a C₁-C₆ halogenated alkyl, an allyl, and a C₃-C₆ aromatic group,
R³ is 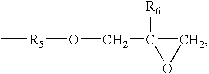
wherein R⁵ is a C₁-C₄ alkylene, and R⁶ is selected from the group consisting of hydrogen, a C₁-C₄ alkyl, and 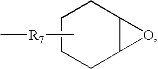
in which R⁷ is selected from the group consisting of hydrogen, a C₁-C₄ alkylene, and a C₁-C₄ alkyl,
R⁴ is a C₁-C₆ alkyl,
a is an integer from 0 to 3, and
b is an integer from 0 to 3.

10. The method of preparing a siloxane-based coating composition according to claim 9, wherein step a) is conducted at a temperature of 20 to 40° C.

11. The method of preparing a siloxane-based coating composition according to claim 9, wherein the aluminum acetyl acetone is added before or after the sol-gel reaction of step a).

12. The method of preparing a siloxane-based coating composition according to claim 9, wherein the alkyl cellosolve is added before or after the sol-gel reaction of step a).

13. The method of preparing a siloxane-based coating composition according to claim 9, wherein the alkyl cellosolve is added after adding the aluminum acetyl acetone.

14. The method of preparing a siloxane-based coating composition according to claim 9, wherein the catalyst is an acidic catalyst or a basic catalyst.

15. The method of preparing a siloxane-based coating composition according to claim 14, wherein said acidic catalyst is at least one acid compound selected from the group consisting of acetic acid, phosphoric acid, sulfuric acid, chloric acid, nitric acid, chlorosulfonic acid, p-toluene sulfonic acid, trichloroacetic acid, polyphosphoric acid, iodic acid, iodic anhydride, and perchloric acid.

16. The method of preparing a siloxane-based coating composition according to claim 14, wherein said basic catalyst is at least one base compound selected from the group consisting of sodium hydroxide, potassium hydroxide, n-butyl amine, di-n-butyl amine, imidazole, and ammonium perchlorate.

17. The method of preparing a siloxane-based coating composition according to claim 9, wherein said solvent is at least one solvent selected from the group consisting of methanol, ethanol, isopropanol, n-propanol, n-butanol, sec-butanol, t-butanol, ethyl acetate, methyl acetate, xylene, and toluene.

18. An optical lens comprising a coating layer(s) prepared from any one coating composition of claims 1 to 8 and having a refractive index of from 1.5 to 1.65.

19. The optical lens according to claim 18, wherein the optical lens is an industrial safety glass or goggles for leisure.
